(19) United States
(12) Patent Application Publication
(10) Pub. No.: US 2009/0092160 A1
(43) Pub. Date: Apr. 9, 2009

(54) EXTERNAL CAVITY LASER WITH A TUNABLE HOLOGRAPHIC ELEMENT

(75) Inventors: Susan Hunter, Fort Collins, CO (US); Ian R. Redmond, Boulder, CO (US); James Jensen, Boulder, CO (US); Kevin R. Curtis, Longmont, CO (US); William L. Wilson, Longmont, CO (US)

Correspondence Address: JAGTIANI + GUTTAG, 10363-A DEMOCRACY LANE, FAIRFAX, VA, 22030, US

(73) Assignee: INPHASE TECHNOLOGIES, INC., LONGMONT, CO (US)

(21) Appl. No.: 12/334,881

(22) Filed: Dec. 15, 2008

Related U.S. Application Data
(62) Division of application No. 11/649,801, filed on Jan. 5, 2007.
(60) Provisional application No. 60/756,556, filed on Jan. 6, 2006.

(51) Int. Cl. H01S 3/10

(52) U.S. Cl. 372/20

(57) ABSTRACT

Embodiments of systems and methods are provided for a tunable laser device. The tunable laser device may include a tunable Bragg reflector that allows its wavelength to be tuned via temperature and/or pressure. This Bragg reflector may include holographic material in which a Bragg grating may be formed comprising parallel fringes of alternating index of refractions. Temperature and/or pressure changes may be effected in the Bragg reflector by, for example, a thermoelectric cooler and/or piezo transducer.

### CROSS-REFERENCE TO RELATED APPLICATIONS

This application makes reference to and claims the benefit of the following co-pending U.S. Provisional Patent Application No. 60/756,556 filed Jan. 6, 2006. The entire disclosure and contents of the foregoing Provisional Application is hereby incorporated by reference.

### BACKGROUND

1. Field of the Invention

The present invention relates broadly to laser systems, and more particularly to external cavity laser systems.

2. Related Art

The use of an external laser cavity with a spectrally selective element has been used for several decades to create a laser with a narrower spectral linewidth than is available with the non-wavelength selective mirrors in the laser cavity of the typical laser. In addition, the tenability of the spectrally selective element may create a laser with an agile wavelength that may be both be narrow in line width and cover a broad tuning range. The spectrally selective element in many non-integrated external cavity lasers may be a diffraction grating. These diffraction gratings may be designed to meet a broad range of laser cavity needs such as size, efficiency, and dispersion. The tuning of the wavelength of the laser may be achieved by adjusting the grating angle of the diffraction grating with respect to the laser beam. Since diffraction gratings may be “thin”, the theory of operation may be modeled with dispersion equations, such as the equations used for modeling the Raman-Nath diffraction regime. These “thin” adjustable diffraction gratings may, however, require complex motor and rotation systems that may significantly increase the cost of the laser system.

In addition to “thin” diffraction gratings, several methods for tuning lasers with external cavity designs that operate with “thick” gratings have been developed. These “thick” diffraction gratings may be modeled with the equations for the Bragg diffraction regime and the Kogelnik coupled wave theory. In some current external cavity laser systems, a Bragg reflector may be used as the spectrally selective element in the external cavity, where the Bragg reflector only reflects light of a certain wavelength while passing all of the other wavelengths. In such systems, the spectrally selective element (i.e., Bragg reflector) may not be tuned by angle, but must instead have the fundamental optical spacing of the holographic grating pattern increase and decrease to create a Bragg reflector at a longer or shorter wavelength (respectively). This modification of the grating pattern may be achieved with fiber based Bragg gratings and electrically tuned Bragg gratings. Such Bragg reflectors, however, may be expensive and not practical in lower cost laser systems.

In addition, Nahata, A., et al., “Widely tunable distributed Bragg reflector laser using a dynamic holographic grating mirror,” IEEE Photonics Technology Letters, 12,(11): 1525-27 (2000), discloses a free space tunable Bragg grating. This system, however, may require a separate laser and mechanical system, which may greatly increase costs to the laser system.

Accordingly there is a need for laser systems with a spectrally selective tuning element that can be customized to have the desired: size, efficiency, and selectivity at a much lower cost than the creation of a new diffraction grating.

### SUMMARY

According to a first broad aspect of the present invention, there is provided a system for generating a coherent light beam, comprising:
a coherent light source;
a lens which collimates light to provide a collimated coherent light beam; and
a reflective device which is tunable to reflect at least a portion of a tuned wavelength of light of the collimated coherent light beam, wherein the reflective device is responsive to at least one of temperature and/or pressure to adjust the tuned wavelength.

According to a second broad aspect of the present invention, there is provided a method for generating a coherent light beam, comprising the following steps:
(a) providing a collimated coherent light beam; and
(b) adjusting at least one of temperature of a reflective device and/or a pressure applied to the reflective device to tune the reflective device such that the reflective device reflects at least a portion of a tuned wavelength of light of the collimated coherent light beam.

According to a third broad aspect of the present invention, there is provided a system for generating a coherent light beam, comprising:
means for providing a collimated coherent light beam;
means for tuning a reflective device; and
means for adjusting at least one of temperature of the tuning means and/or a pressure applied to the tuning means such that the tuning means reflects at least a portion of a tuned wavelength of light of the collimated coherent light beam.

### BRIEF DESCRIPTION OF THE DRAWINGS

The invention will be described in conjunction with the accompanying drawings, in which:

FIG. 1 illustrates an exemplary laser system, in accordance with embodiments of methods and systems of the present invention;

FIG. 2 illustrates an exemplary tunable Bragg reflector, in accordance with embodiments of methods and systems of the present invention;

FIG. 3 illustrates an alternative exemplary embodiment of a tunable Bragg reflector, in accordance with embodiments of methods and systems of the present invention;

FIG. 4 illustrates yet another alternative exemplary embodiment of a tunable Bragg reflector, in accordance with embodiments of methods and systems of the present invention;

FIG. 5 illustrates normalized efficiency curves for an exemplary Bragg reflector, in accordance with embodiments of methods and systems of the present invention;

FIG. 6 provides an exemplary flow chart of a method for designing a tunable Bragg reflector, in accordance with embodiments of methods and systems of the present invention;

FIG. 7 illustrates a simplified diagram of an optical system for fabricating a tunable Bragg reflector, in accordance with embodiments of methods and systems of the present invention;

FIG. 8 illustrates a simplified emission of a laser which utilizes an exemplary tunable Bragg reflector, in accordance with embodiments of methods and systems of the present invention;

FIG. 9 illustrates an alternative exemplary laser system, in accordance with embodiments of methods and systems of the present invention; and

FIG. 10 illustrates an alternative exemplary laser system, in accordance with embodiments of methods and systems of the present invention.

### DETAILED DESCRIPTION

It is advantageous to define several terms before describing the invention. It should be appreciated that the following definitions are used throughout this application.

### Definitions

Where the definition of terms departs from the commonly used meaning of the term, applicant intends to utilize the definitions provided below, unless specifically indicated.

For the purposes of the present invention, the term “light source” refers to a source of electromagnetic radiation having a single wavelength or multiple wavelengths. The light source may be from a laser, a laser diode, one or more light emitting diodes (LEDs), etc.

For the purposes of the present invention, the term “coherent light beam” refers to a beam of light including waves with a particular (e.g., constant) phase relationship, such as, for example, a laser beam.

For the purposes of the present invention, the term “processor” refers to a device capable of executing instructions and/or implementing logic. Exemplary processors may include application specific integrated circuits (ASIC), central processing units, microprocessors, such as, for example, microprocessors commercially available from Intel and AMD, etc.

For the purposes of the present invention, the term “reflective device” refers to a device capable of reflecting light. Exemplary reflective devices comprise Bragg reflectors, including, for example, tunable Bragg reflectors, etc.

For the purposes of the present invention, the term “Bragg reflector” refers to a device capable of reflecting light of a particular wavelength while allowing other wavelengths to pass through the device.

For the purpose of the present invention, the term “tunable Bragg reflector” refers to a Bragg reflector in which the particular wavelength of light reflected may be adjusted.

For the purpose of the present invention, the term “collimated light beam” refers to a beam of light comprising surfaces of approximately constant phase that are approximately parallel and normal to the direction of propagation. For example, in embodiments, a collimated light beam may have surfaces of constant phase that are as close to parallel as possible and normal to the direction of propagation.

For the purpose of the present invention, the term “plane wave” refers to a constant-frequency wave whose wavefronts (surfaces of constant phase) are parallel planes of constant amplitude and normal to the direction of the wave and exist in a localized region of space. Exemplary plane waves may include collimated light such as those associated with laser beams for laser pointers, etc.

For the purpose of the present invention, the term “Bragg grating” refers to a device comprising a periodic or aperiodic of the effective index of refraction of the device. Exemplary Bragg gratings may comprise a fringe pattern stored in a holographic material in which the fringe pattern comprises fringes of alternating indices of refraction, or a layered stack of materials with alternating indices of refraction, etc.

For the purpose of the present invention, the term “tune” refers to adjusting a device to a desired state. For example, in exemplary embodiments, a Bragg reflector may be tuned by adjusting the particular wavelength reflected by the Bragg reflector to a desired wavelength.

For the purpose of the present invention, the term “substrate” refers to a layer of material. Exemplary substrates may include, for example, transparent materials, such as, for example, glass, plastic, etc.

For the purpose of the present invention, the term “thermoelectric device” refers to a device capable of effecting a temperature change in itself or another device. Exemplary thermoelectric devices may comprise thermoelectric coolers (also commonly referred to as TECs or Peltier devices) in which an increase or decrease in temperature may be created by adjusting the direction and magnitude of the current through the device. Additionally, a resistor is a simple exemplary thermoelectric device that although may not be able to reduce the temperature, but can be effective at creating heat when current is applied. It should be noted that these are exemplary thermoelectric devices, and in embodiments other heating and cooling devices may be used.

For the purpose of the present invention, the term “transducer” refers to any type of device capable of converting one type of energy to another type of energy. Exemplary transducers may comprise piezo actuators, thermoelectric devices, etc.

For the purpose of the present invention, the term “optical cavity” refers to a space between two reflective devices. Exemplary optical cavities may comprise the space between reflective devices in a laser system, such as, for example, the space between a reflective coating on a facet of a laser diode and a Bragg reflector, diffraction grating, mirror, etc.

For the purpose of the present invention, the term “external cavity” refers to a portion of an optical cavity that is external to a component of a laser system that is the source of the photons and optical gain. Exemplary external cavities comprise the portion of an optical cavity of a laser system between a laser diode and a reflective device (e.g., a Bragg reflector) external to the laser diode, and usually provide control over the longitudinal and/or transverse mode structure of the laser.

### Description

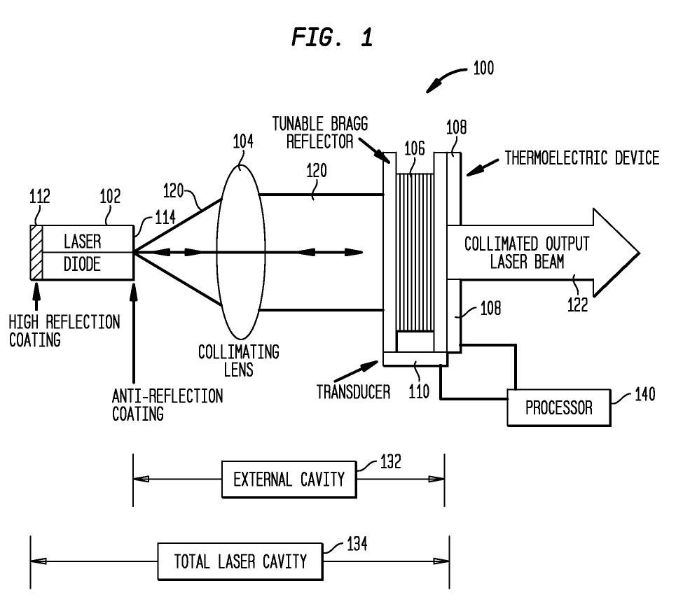

FIG. 1 illustrates an exemplary laser system, in accordance with methods and systems consistent with the present invention. As illustrated, laser system 100 may comprise a laser diode 102, a collimating lens 104, a tunable Bragg reflector 106, a thermoelectric device 108, a transducer 110, and a processor 140. Laser system 100 may be, for example a laser system such as used in holographic memory systems. Laser diode 102 may be, for example, any type of device capable of producing a coherent light beam, such as, for example, a semiconductor device capable of producing a coherent light beam. Further, laser diode 102 may include a highly reflective coating 112 on its facet opposite the external cavity 132 and an anti-reflective coating 114 on laser diode 102's other facet. Processor 140 may be any type of processor, such as, for example a commercially available microprocessor.

Collimating lens 104 may be a high quality collimating lens, such as those commercially available. Tunable Bragg reflector 106 may be, for example, a Bragg reflector capable of being tuned by adjusting the pressure and/or temperature of Bragg reflector 106. Further, in laser system 100 tunable Bragg reflector 106 may have a reflectivity of, for example, from about 10 to about 50%. A further description of an exemplary tunable Bragg reflector 106 is provided below along with an explanation regarding tuning Bragg reflector 106 using thermoelectric device 108 and/or transducer 110.

In operation, laser system 100, may be comprised of a laser diode 102 that generates and amplifies the coherent light beam 120 along with the collimating lens 104 and tunable Bragg reflector 106 which may be used to tune laser system 100 to a desired wavelength of light by sending only a selected portion of the light back to the laser diode 102. For example, in operation, tunable Bragg reflector 106 may reflect a particular wavelength of light (i.e., the tuned wavelength) back towards laser diode 102 while wavelengths other than the tuned wavelength may be transmitted. Since a laser amplifies the photon energy on each round trip through the total laser cavity 134, the external cavity 132 may be used to selectively allow only one (or a few) wavelengths to dominate.

As noted above, tunable Bragg reflector 106 may have, for example, a reflectivity of between about 10% and about 50% in the present embodiment of laser system 100. Thus, in operation, tunable Bragg reflector 106 may transmit almost all of the light incident upon it except for the reflection of about 10 to about 50% of light at the tuned wavelength (i.e., about 10 to about 50% of the light in coherent light beam 120 at the tuned wavelength). In addition, the Bragg reflector allows the remaining light at the tuned wavelength, from about 50 to about 90%, to pass through tunable Bragg reflector 106 to form collimated output laser beam 122. The reflected light from tunable Bragg reflector 106 may then pass back through collimating lens 104 and laser diode 102 where it may then be reflected back by reflective coating 112. Reflective coating 112 may be a highly reflective coating, such as, for example, a coating that reflects greater than about 95% of incident light.

Tunable Bragg reflector 106 may, as noted above, be tuned, for example, by changing the temperature and/or pressure of tunable Bragg reflector 106. For example, thermoelectric device 108 may be used to change the temperature of Bragg reflector 106 to adjust the wavelength to which Bragg reflector 106 is tuned. Similarly, transducer 110 may be used to change the pressure applied to Bragg reflector 106 to adjust Bragg reflector 106's tuned wavelength.

Thermoelectric device 108 may be any type of device capable of effecting a desired temperature change in Bragg reflector 106, such as, for example, a thermoelectric cooler (also commonly referred to as a Peltier cooler) or, for example, any other type of commercially available thermoelectric device. Processor 140 may be used to control thermoelectric device 108 to adjust its temperature to either, for example, increase or decrease the temperature of tunable Bragg reflector 106. In an embodiment of laser system 100, Bragg reflector 106 may exhibit a tuned wavelength shift of 0.21 nm/degree Celsius. That is, a one degree Celsius shift in temperature of Bragg reflector 106 will result in a corresponding 0.21 nm shift in the tuned wavelength of Bragg reflector 106.

Further, in laser system 100, thermoelectric device 108 may be attached to the back of Bragg reflector 106 and may include a cutout (e.g., a hole in its center) to permit collimated output beam 122 to exit laser system 100.

Additionally, a transducer 110 may be used to adjust the pressure applied to Bragg reflector 106 to shift the tuned wavelength of Bragg reflector 106. Transducer 110 may, for example, be a piezo transducer (also referred to as a piezo actuator). Processor 140 may be used to control transducer 110 to adjust the pressure applied to Bragg reflector 106. For example, transducer 110 may either squeeze together Bragg reflector 106 or push apart Bragg reflector 106 at different pressures to adjust the wavelength to which Bragg reflector 106 is tuned. In an embodiment of laser system 100, Bragg reflector 106 may exhibit a tuned wavelength shift of, for example, about 1% of the originally tuned wavelength of Bragg reflector 106 with the application of moderate pressure. A further description of exemplary tunable Bragg reflectors 106 that may be tuned by adjusting the applied pressure is provided below.

Further, although laser system 100 may use both a thermoelectric device 108 and a transducer 110 for adjusting the temperature and/or applied pressure of Bragg reflector 106, respectively, it should be noted that in other embodiments of laser system 100, only one or the other may be used. For example in an alternative embodiment of laser system 100, a thermoelectric device 108 may be used but no transducer 110, or, for example, a transducer 110 may be included in laser system 100, but no thermoelectric device 108. That is, in these alternative embodiments of laser system 100, temperature, pressure, or both temperature and pressure may be used in adjusting the wavelength to which Bragg reflector 106 is tuned.

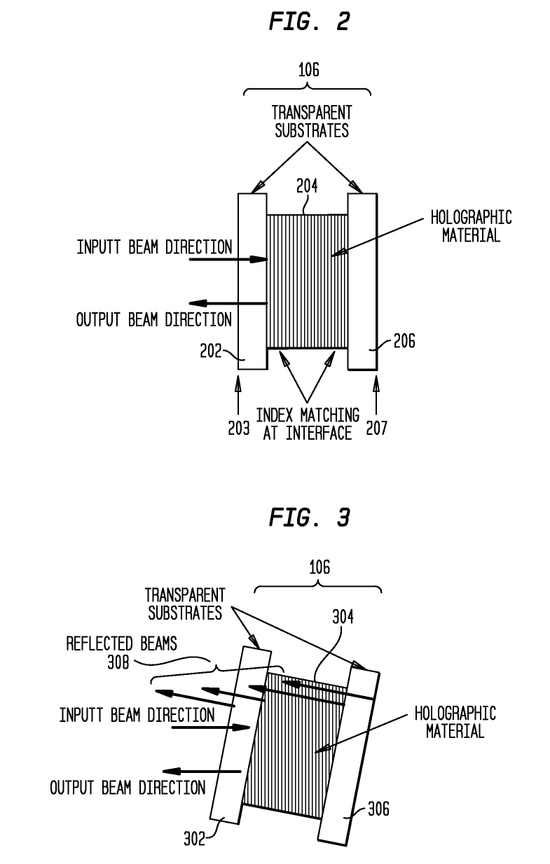

In order to reduce reflections inside the laser cavity 134 to create a more stable and tunable laser, anti-reflection coatings may be provided on collimating lens 104 and the diode facet 114 inside the external cavity 132. In addition, laser system 100 may be designed to have low on-axis reflections from the air and material interfaces in order to reduce competition with the fundamental mode that is tuned in the laser cavity 134. This may be achieved, for example, by using anti-reflection coatings and introducing tilts, as will be discussed in more detail below with reference to FIGS. 2-4.

FIG. 2 illustrates an exemplary tunable Bragg reflector 106, in accordance with embodiments of the methods and systems of the present invention. As illustrated, tunable Bragg reflector 106 comprises two (2) transparent substrates 202 and 206 and a holographic material 204 between the two substrates 202 and 206. Substrates 202 and 206 may be, for example, any optically transparent material, such as, for example, glass, plastic, etc. Holographic material 204 may be, for example, photopolymers, such as those described in, for example, U.S. Pat. No. 6,939,648 (Dhar, et al.) issued Sep. 6, 2005, the entire contents and disclosures of which are herein incorporated by reference. Further, in an embodiment of tunable Bragg reflector 106, holographic material 204 may have a fringe pattern recorded within the holographic material 204 that functions as a Bragg reflector or Bragg grating such that Bragg reflector 106 reflects the tuned wavelength. A further description of an exemplary method for recording such a fringe pattern in holographic material 204 is provided below.

In order to reduce on-axis reflections at the interfaces of the substrates 202 and 206, anti-reflection coatings 203 and 207 may be applied to the exterior surfaces of substrates 202 and 206, respectively. Further, index matching may be used to reduce on-axis reflections. For example, the index of refraction of substrates 202 and 206 may be such that they are the same as or matched to the index of refraction of holographic material 204.

FIG. 3 illustrates an alternative exemplary embodiment of tunable Bragg reflector 106, in accordance with embodiments of the methods and systems of the present invention. As illustrated, Bragg reflector 106 may comprise two (2) transparent substrates 302 and 306 and a holographic material 304 between the two substrates 302 and 306. Substrates 302 and 306 and holographic material 304 may be the same types of materials, such as discussed above with reference to substrates 202 and 206 and holographic material 204 of FIG. 2. In order to reduce on-axis reflection at the interfaces of the substrates, substrates 302 and 306 may be tilted in this example to direct the reflected beams 308 off-axis.

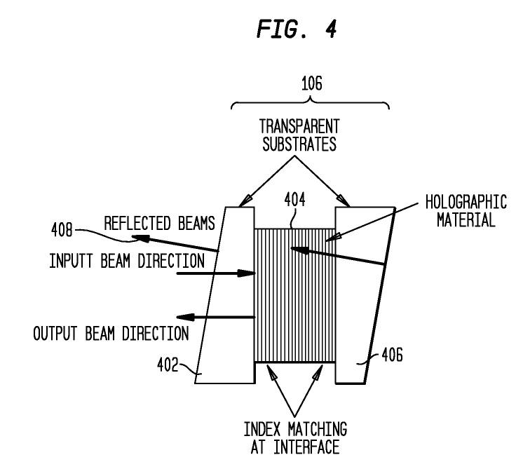

FIG. 4 illustrates yet another alternative exemplary embodiment of tunable Bragg reflector 106, in accordance with embodiments of the methods and systems of the present invention. As illustrated, Bragg reflector 106 comprises two transparent substrates 402 and 406 and a holographic material 404 between the two substrates 402 and 406. Substrates 402 and 406 and holographic material 404 may be the same types of materials, such as discussed above with reference to above with reference to substrates 202 and 206 and holographic material 204 of FIG. 2. In order to reduce on-axis reflection at the interfaces of the substrates, substrates 402 and 406 may be wedge-shaped in this example to maintain parallel fringes inside the hologram but to direct the reflected beams 408 off-axis.

As is known to those of skill in the art, it is generally desired in laser systems to only have one longitudinal mode in the laser beam at any one time. Bragg reflector 106 may therefore be designed such that it operates, as noted above, as an optical spectral filter that preferentially reflects the desired wavelength (i.e., the single desired longitudinal mode) and causes other wavelengths to exit the laser cavity and therefore not complete a roundtrip or experience the gain necessary to create a laser. A description of the theoretical reflection profiles from Bragg reflectors may be found in Herwig Kogelnik, “Coupled Wave Theory for Thick Hologram Gratings,” Bell System Technical Journal 48: 2909-47 (1969), which is herein incorporated by reference.

The maximum diffraction efficiency (sometimes also referred to as the reflectivity) of a Bragg reflector may be calculated as ηₒ as follows:

ηₒ=tan h²(πΔnd/λₒ) (Equation 1)

where d is the thickness of the holographic material 204/304/404 of Bragg reflector 106, λₒ is the optimum wavelength for the Bragg reflector (i.e., the wavelength to which Bragg reflector 106 is tuned), and Δn is the difference in the index of refraction between fringes recorded in holographic material 204/304/404 of Bragg reflector 106 (i.e., the difference between the maximum index of refraction for a fringe and the minimum index of refraction for a fringe).

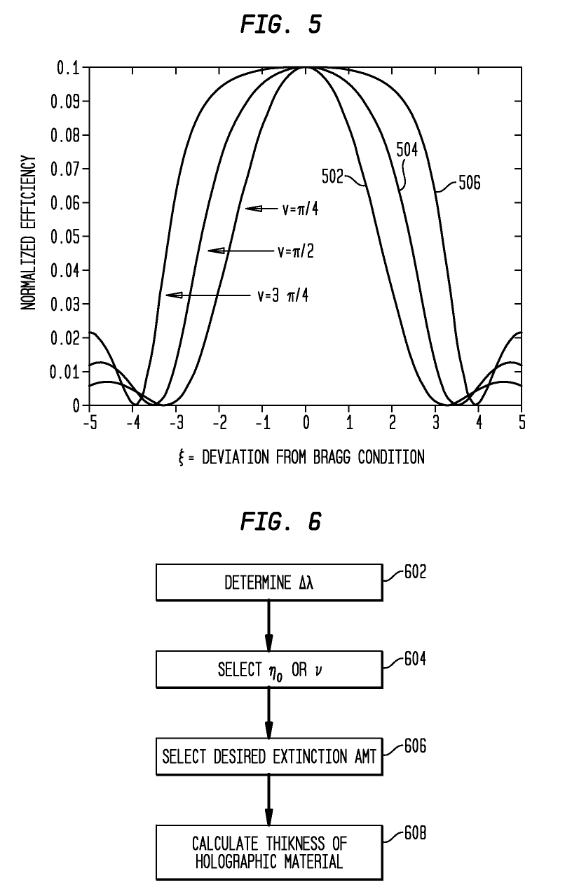

FIG. 5 illustrates normalized efficiency curves (η/ηₒ) for an exemplary Bragg reflector 106, in accordance with embodiments of the methods and systems consistent of the present invention. These curves may be mathematically defined as:

$$η = {[ 1 + \frac{1 - {ξ}^{2} / {v}^{2}}{{sinh}^{2} ( \sqrt{{v}^{2} - {ξ}^{2}} )} ]}^{- 1} \qquad ( Equation 2 )$$

where η is the diffraction efficiency, v and ξ are determined by the properties of the Bragg grating 106 recorded in the holographic material 204/304/404 and by the properties of the optical beam incident on the Bragg grating:

v=πΔnd/(λₒ cos θₒ) (Equation 3)

ξ=(Δλ/λₒ)(2πnd/λₒ) cos θₒ (Equation 4)

where n is the average index of refraction and Δn is the change in index of refraction in the periodic structure of the Bragg reflector, d is the thickness of the Bragg gratings Δλ is the difference between wavelength of light of interest and the wavelength of light that experiences the highest diffraction (λₒ), Δλ=λᵢₙₜₑᵣₑₛₜ−λₒ, and θₒ is the angle of incidence of coherent light beam 120 on the normal to the fringes of the Bragg reflector 106 (typically, θₒ=0).

As is known to those skilled in the art, the ideal spectral curve for a Bragg hologram as a wavelength selective element (i.e., a device capable of tuning a laser to a particular wavelength) in a laser cavity may be determined based on a desired amount of feedback (i.e., reflectivity) to the laser at the center wavelength, λₒ, and when there is a significant extinction of the neighboring cavity modes at λₒ±Δλ (i.e., wavelengths other than the desired wavelength, λₒ, are sufficiently repressed) where:

Δλ=λ_{center}²/2L (Equation 5)

and L is the length of the laser cavity and λ_{center} is the wavelength with the most power in the laser.

Thus, as illustrated in FIG. 5, smaller modulation parameters, v, may result in a narrow line width of collimated output beam 122. Particularly, as illustrated in FIG. 5, curve 502 is the normalized efficiency curve for v=π/4, curve 504 is the normalized efficiency curve for v=π/2, and curve 506 is the normalized efficiency curve for v=3π/4. As illustrated, exemplary curve 502 may have a narrower line width than curves 504 and 506.

FIG. 6 provides an exemplary flow chart of an embodiment of a method in accordance with the present invention, for designing a tunable Bragg reflector 106 of FIG. 1. In this example, Bragg reflector 106 may be designed for use in laser system 100 with a desired center wavelength λₒ=406 nm and a cavity length (L)=15 mm.

First, the cavity mode spacing, Δλ, may be computed (Step 602). As noted above, Δλ=λₒ²/2L. Thus, in this example, Δλ=5.5 pm=0.0055 nm. Next, the modulation parameter, v, or the desired maximum diffraction efficiency, ηₒ, may be selected (Step 604). As noted above, in laser system 100, the desired reflectivity may be, for example, between about 10% and about 50%. Thus, in this example a desired reflectivity of 12% may be arbitrarily selected. Thus, in this example the desired maximum diffraction efficiency, ηₒ, may be 0.12.

The desired amount of extinction of the adjacent modes (i.e., the desired suppression of modes other than the desired mode) may also be selected (Step 606). In this example, the desired amount of extinction may be arbitrarily selected as 10% for an extinction of 10%, or the point where ξ where results in a normalized efficiency of η/ηₒ=0.90. This point may be referred to as ξ₉₀. In an embodiment of laser system 100, curves such as illustrated in FIG. 5 may be used to determine the value ξ at the ξ₉₀ point.

The corresponding thicknesses, d, of holographic material 204/304/404 to be used to achieve the desired ξ₉₀ point may then be calculated (Step 608). Table 1, below, illustrates calculated thicknesses, d, for the 3 exemplary values of the modulation parameter, v, plotted in FIG. 5. Further, Table 1 illustrates the potential range of exemplary possible peak diffraction efficiencies for these different modulation parameters, v, and the corresponding maximum diffraction efficiencies, ηₒ.

TABLE 1
3 Designs for Bragg Reflector

| | | ξ₉₀ = Point | |
|---|---|---|---|
| | | where | d = Material |
| | Maximum | Diffraction | Thickness required |
| ν = | Diffraction | efficiency is | to suppress mode |
| modulation | Efficiency | 90% of max | at Δλ = 5.5 pm |
| parameter | (from Eq. 1) | (from Eq. 2) | (from Eq. 4) |
| π/4 | 43% | 0.74 | 2.4 mm |
| π/2 | 84% | 1.32 | 4.2 mm |
| 3π/4 | 96% | 2.24 | 7.2 mm |

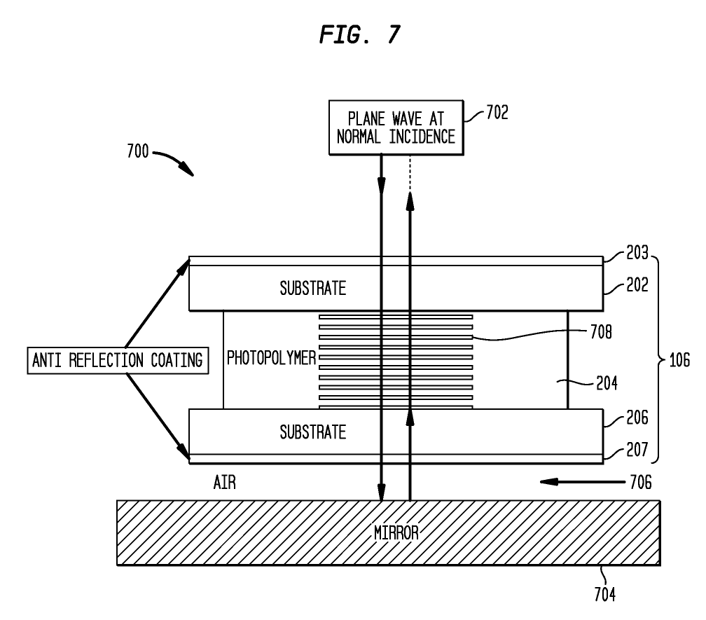

FIG. 7 illustrates a simplified diagram of an optical system 700 for fabricating a Bragg reflector 106 with a desired Bragg diffraction pattern. In this example, the Bragg reflector may be a Bragg reflector 106, such as illustrated in FIG. 2. It should be noted that the geometry of FIG. 7 is arbitrary and provided for illustrative purposes. Further, in this example, the thickness of holographic material 204 may be determined using a method such as described above with reference to FIG. 6.

As illustrated in FIG. 7, Bragg reflector 106 may be fabricated by placing a sample of unexposed photopolymer 204 above a mirror 704. Mirror 704 may be a high quality mirror with a high reflectivity, such as, for example, a high reflectivity commercially available mirror. In this example, the gap 706 between the lower substrate 206 and mirror 704 may be small and filled with air. A plane wave 702 at a normal incidence (i.e., an angle of incidence of zero, θₒ,=0) is directed towards the photopolymer 204. Plane wave 702 may be generated by a single laser system, such as, for example, laser system 100 tuned to a desired wavelength, λ. Plane wave 702 may pass through the photopolymer 204 where it may be reflected back through the photopolymer 204. The plane wave 702 may interact with this reflected plane wave to produce a diffraction pattern 708 (also referred to herein as Bragg grating) in material 204. Diffraction pattern 708 may be comprised of straight parallel fringes each having alternating indexes of refraction, n₁ and n₂, where n₁>n₂ and Δn=n₁−n₂.

Although FIG. 7 is described with reference to Bragg reflector 106 of FIG. 2, optical system 700 may also be used to impart a desired diffraction pattern 708 in the photopolymer to create the devices shown in FIGS. 3 and 4. For example, a desired diffraction pattern may be imparted in the Bragg reflector 106 of FIG. 3 by tilting the assembly 106 at a desired angle with respect to the optical axis of plane wave 702 when it is placed in optical system 700. In addition, in an alternative embodiment, rather than using anti-reflection coatings on the bottom surface of Bragg reflector 106 during recordation of diffraction pattern 708, Bragg reflector 106 may be placed in close proximity to mirror 704 and index matching fluid applied to gap 706. Index matching fluid is known to those of skill in the art, and is not described further herein.

During the recording of diffraction pattern 708, optical system 700 may be very rigid and the length of exposure (i.e., the amount of time plane wave 702 is applied to create the Bragg reflector) may be short with respect to the photo-induced index of refraction changes that occur in the holographic material 204. This may be accomplished, for example, by using a plane wave with a significant power (i.e., intensity). Using a high intensity plane wave 702 with a short duration may help reduce optical changes in Bragg reflector 106 during exposure, which may result in coupling between the recorded hologram (i.e., fringe pattern) and the plane wave 702 that may cause second order gratings to be recorded and decrease the performance of the resulting Bragg reflector 106.

The following provides a description of tuning the wavelength of a Bragg reflector fabricated using optical system 700 that provides lasing with a single longitudinal mode. As noted above, photopolymer material 204 may be used to create a Bragg reflector 106 with the desired reflectivities for a range of wavelengths at a desired temperature and pressure. This polymeric material may exhibit a strong change in thickness and/or index of refraction with an increase in temperature. For example, the Bragg wavelength shift on an exemplary polymeric material may be 0.21 nm/° C. That is, the material may exhibit a 0.21 nm shift in the wavelength of light reflected by the imparted diffraction pattern 708 for each one Celsius degree shift in the temperature of the holographic material 204. Although this is one example of an exemplary Bragg wavelength shift, in other embodiments, materials with other Bragg wavelength shifts may be used. Further, different embodiments may use different holographic materials 204 and substrates 202 and 206 with different sensitivity to temperature depending on the desired properties of laser system 100.

In addition, embodiments of holographic material 204 may be used that remain flexible even when the diffraction pattern 708 in holographic material 204 is fully cured. Using such a holographic material 204 may be beneficial in laser systems 100 in which the laser system 100 may be tuned by pressure where holographic material 204 may be mechanically squeezed or pulled to shift the center wavelength of the grating. While the amount of Bragg wavelength shift due to applied pressure may not be fully characterized, it may be expected to provide at least about a 1% change in the center wavelength with moderate applied pressures.

As noted above, laser system 100 may operate with temperature tuning or pressure tuning or a combination of both temperature and pressure tuning, since the two techniques may provide tunability with, for example, different time constants, total range, resolution, etc.

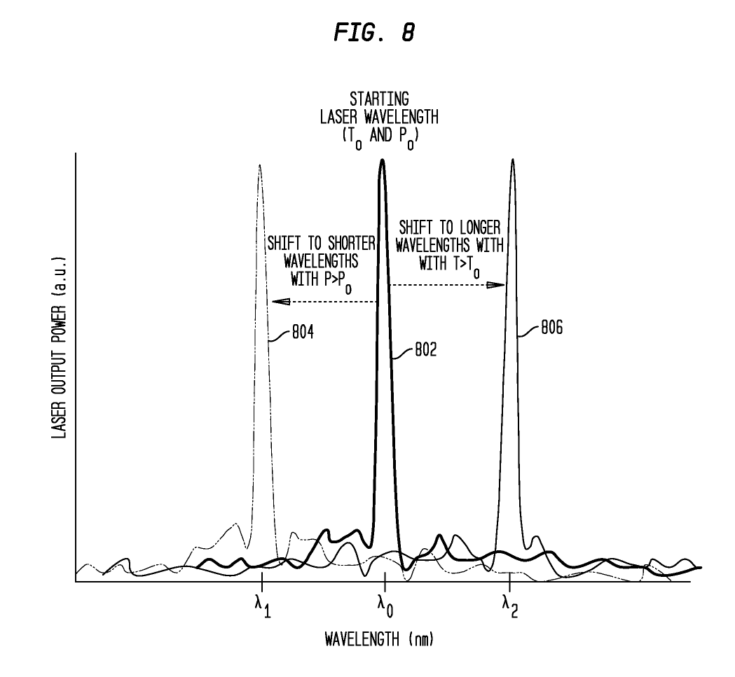

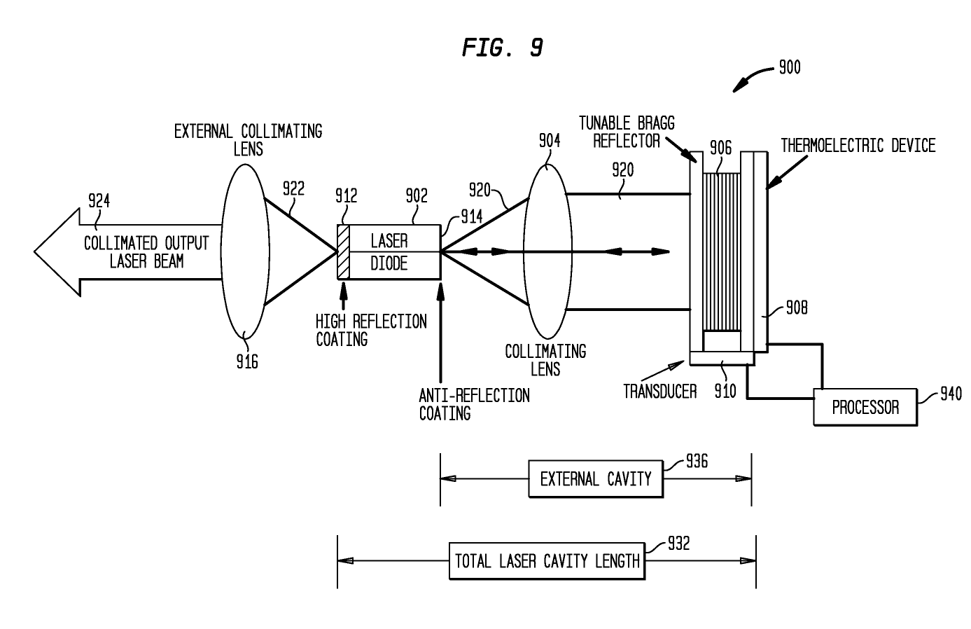

FIG. 8 illustrates a simplified diagram of exemplary optical spectral curves for an exemplary tunable output beam 122 in accordance with embodiments of the present invention. These exemplary curves illustrate how increases in the temperature and/or pressure may be used to adjust the wavelength to which laser system 100 is tuned. In this example, curve 802 illustrates an exemplary intensity pattern for laser system 100 versus wavelength for a pressure, P₀, and temperature, T₀. As illustrated curve 802 exhibits a peak at wavelength λₒ. Curve 804 illustrates an exemplary intensity versus wavelength curve when the pressure applied to Bragg reflector 106 may be increased from P₀ to P, while the temperature, T₀, remains constant. As illustrated by curve 804, this increase in pressure results in a change in tuned wavelength for laser system 100 from λₒ to λ₁. Curve 806 illustrates an exemplary intensity versus wavelength curve when the temperature applied to Bragg reflector 106 is increased from T₀ to T, while the pressure, P₀, remains constant. As illustrated by curve 806 this increase in temperature results in a change in tuned wavelength for laser system 100 from λₒ to λ₂.

FIG. 9 illustrates an alternative exemplary laser system 900, in accordance with methods and systems consistent with the present invention. As illustrated in FIG. 9, laser system 900 may comprise a laser diode 902, a collimating lens 904, a tunable Bragg reflector 906, a thermoelectric device 908, a transducer 910, another collimating lens 916, and a processor 940. Laser system 900 may be similar to laser system 100, but with the exception that, rather than collimated output beam 122 exiting tunable Bragg reflector 106, in laser system 900 tunable Bragg reflector 906 may be a highly reflective and collimated output beam 924 which may exit from the opposite side of laser system 900 from tunable Bragg reflector 906. Using a geometry or configuration such as that illustrated in laser system 900 may be useful in applications where having the collimated output beam 924 exit Bragg reflector 906 may not be practical, such as, for example, in applications where electronics or components need to be placed on the opposite side of tunable Bragg reflector 906.

As in laser system 100, laser diode 902 may be, for example, any type of device capable of producing a coherent light beam, such as, for example, a semiconductor device capable of producing a coherent light beam. Because in laser system 900, output beam 924 exits from the opposite side of laser system 900 (relative to what is shown in laser system 100), laser diode 902 may include a partially reflective coating 912 on its facet opposite the external cavity 936 (e.g., the portion of the total laser cavity 932 external to laser diode 902) rather than a highly reflective coating as in laser system 100. Laser diode 902 may include an anti-reflective coating 914 on laser diode 902's other facet. Processor 940 may be any type of processor, such as, for example a commercially available microprocessor. Collimating lenses 904 and 916 may be any type of lens, such as those commercially available.

As in laser system 100, tunable Bragg reflector 906 may be, for example, a Bragg reflector capable of being tuned by adjusting the pressure and/or temperature thereof. Further, in FIG. 9, tunable Bragg reflector 906 may be highly reflective (e.g., a reflectivity of greater than 95%). Tunable Bragg reflector 906 may be, for example, the same type as tunable Bragg reflector 106 and may be fabricated in the same manner as discussed above.

In operation, laser diode 902 generates a coherent light beam 920 that may then be collimated by collimating lens 904. Coherent light beam 920 may then pass into tunable Bragg reflector 906 which may tune laser system 900 to a desired wavelength of light. Thus, in operation, tunable Bragg reflector 906 may reflect a particular wavelength of light (i.e., the tuned wavelength) back towards laser diode 902 while wavelengths other than the tuned wavelength are transmitted. As noted above, in laser system 900, tunable Bragg reflector 906 may be highly reflective for a very narrow range of optical wavelengths. The reflected light may then pass back through collimating lens 904 and laser diode 902 where it may be partially reflected by partially reflective coating 912. Partially reflective coating 912 may, for example, reflect from about 10 to about 50% of incident light, but allow the remaining from about 50 to about 90% of the light to pass through partially reflective coating 912. Light 922 exiting partially reflective coating 912 may then be collimated by collimating lens 916 to form collimated output laser beam 924. To function as a laser, there may be amplification of the optical power inside the laser cavity that has a total length shown as Total Laser Cavity Length 932.

As with Bragg reflector 106 of laser system 100, tunable Bragg reflector 906 of laser system 900 may be tuned, for example, by changing the temperature and/or pressure of tunable Bragg reflector 906. For example, as in laser system 100, thermoelectric device 908 may be used to change the temperature of Bragg reflector 906 to adjust the wavelength to which Bragg reflector 906 is tuned. Similarly, transducer 910 may be used to change the pressure applied to Bragg reflector 906 to adjust Bragg reflector 906's tuned wavelength. As in laser system 100, thermoelectric device 908 may be applied or positioned to the back side of laser system 900, and may be, for example, any type of device capable of adjusting the temperature of Bragg reflector 906, such as, for example a commercially available thermoelectric cooler. As in laser system 100, processor 940 may be used to control thermoelectric device 908 to adjust its temperature to either, for example, increase or decrease the temperature of tunable Bragg reflector 906. For example, in an embodiment, Bragg reflector 906 may exhibit a tuned wavelength shift of 0.21 nm/degree Celsius.

Additionally as in laser system 100, a transducer 910 may be used to adjust the pressure applied to Bragg reflector 906 to shift the tuned wavelength of Bragg reflector 906. Transducer 910 may, for example, be a piezo transducer (also referred to as a piezo actuator). Processor 940 may be used to control transducer 910 to adjust the pressure applied to Bragg reflector 906. For example, transducer 910 may either squeeze together Bragg reflector 906 or push apart Bragg reflector 906 at different pressures to adjust the wavelength to which Bragg reflector 906 is tuned.

Further, although laser system 900 may use both a thermoelectric device 908 and a transducer 910 for adjusting the temperature and/or applied pressure of Bragg reflector 906, respectively, in embodiments of laser system 900 (as in embodiments of laser system 100), either a thermoelectric device 908 or a transducer 910 may be used or, for example, both.

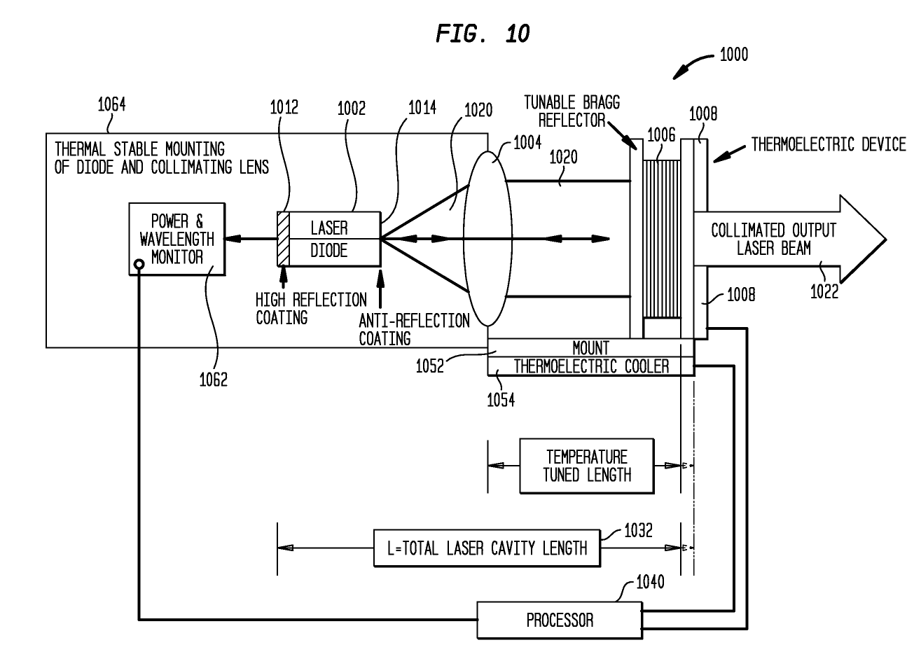

FIG. 10 illustrates an alternative exemplary laser system, in accordance with embodiments of the methods and systems of the present invention. As illustrated, laser system 1000 may comprise a laser diode 1002, a collimating lens 1004, a tunable Bragg reflector 1006, a thermoelectric device 1008, a mount 1052, another thermoelectric device 1054, a monitor 1062, another mount 1064, and a processor 1040. Laser system 1000 may be similar to laser system 100, but with the exception that laser system 1000 may be tuned by both tuning tunable Bragg reflector 1006 and by adjusting the cavity length, L, of cavity 1032, of laser system 1000. This may help to enable laser system 1000 to provide mode hop free tuning. That is, laser system 1000 may provide more continuous tuning of laser system 1000's wavelength.

A laser system with a fixed cavity length may only be able support generation of laser beams with wavelengths capable of resonating within this fixed optical cavity length. As one skilled in the art may be aware, a wavelength may be capable of resonating within an optical cavity if a discrete number of half-wavelengths fit within the optical cavity such that the light constructively interferes with itself when reflected. In contrast, wavelengths slightly different than the tuned wavelength of the laser system may not discretely fit within the optical cavity and therefore will destructively interfere with themselves when reflected back and forth inside the laser cavity. Thus, in typical laser systems with a fixed cavity length, the laser may only be capable of supporting discrete wavelengths. The wavelengths that discretely fit within the optical cavity may be referred to as the longitudinal modes of the laser.

Laser system 1000 permits mode hop free tuning by permitting the total optical length, L, of cavity 1032 to change proportionally to the change in the tuned wavelength of tunable Bragg reflector 1006. That is, in laser system 1000, if the tuned wavelength is changed, for example, by about 1% in wavelength, the cavity length, L, 1032 of laser system 1000 may also be changed by 1%. Mathematically speaking, if the starting wavelength is λₒ and cavity length is Lₒ, to tune to a new wavelength λ_{new}=λₒ+Δλ, then the cavity length may be changed to Lₒ+ΔL, where:

$$\frac{Δλ}{{λ}_{0}} = \frac{Δ L}{{L}_{0}} \qquad ( Equation 6 )$$

In laser system 1000, tuning may be accomplished by, for example, processor 1040 directing thermoelectric device 1008 to alter the temperature of Bragg reflector 1006 to induce an adjustment to the tuned wavelength of Bragg reflector 1006. Simultaneously, processor 1040 may direct thermoelectric device 1054 to induce a corresponding temperature change in mount 1052. For example, mount 1052 may be manufactured from a metallic or other substance in which its length changes based on its temperature. Thus, for example, thermoelectric device 1054 may increase the temperature of mount 1052 to induce an increase in the total cavity length, L, of cavity 1032. Alternatively, a decrease in temperature of mount 1052 may decrease the total cavity length, L, of cavity 1032. Thus, in operation processor 1040 may direct both a temperature change to Bragg reflector 1006 and a corresponding temperature change in mount 1052 to enable mode hop free tuning in laser system 1000.

Additionally, in this embodiment of laser system 1000, laser diode 1002 and lens 1004 may be mounted on a thermally stable mount 1064, which maintains a constant length.

Additionally, monitor 1062 may be used to monitor laser system 1000, such as for example, to determine whether laser system 1000 is generating an output laser beam 1022 with the desired tuned wavelength. Monitor 1062 may be for example, any type of device capable of detecting a light, such as, for example a device capable of detecting an intensity and wavelength of an incident light beam. Exemplary monitors 1062 include, for example, a photodetector, a wavelength sensitive photodetector, a power meter, etc.

In laser system 1000, a highly reflective coating 1012 may be applied to a facet of laser diode 1002 opposite the laser cavity 1032 and an anti-reflective coating 1104 on laser diode 102's other facet 1014. Highly reflective coating 1012 may have, for example, a reflectivity of greater than about 95% (but less than 100%). Thus, a small percentage of the optical beam 1020 may pass through highly reflective coating 1012. This light that passes through may be detected by monitor 1062, which may detect, for example, the wavelength and intensity of this light. This information may then be provided to processor 1040, which may use this information to alter the temperature induced in Bragg reflector 1006 and mount 1052 to help fine tune collimated output laser beam 1022. For example, if intensity of the laser beam is decreasing as the wavelength is tuned, processor 1040 may determine that the cavity length, L, of cavity 1032 is incorrect and direct thermoelectric device 1054 to adjust its temperature until the desired intensity is determined. This may be accomplished, for example, by first decreasing the temperature and determining the resulting intensity of light detected by monitor 1062. If the intensity level decreases rather than increases, processor 1040 may induce a temperature change in mount 1052 in the opposite direction. Similarly, if monitor 1062 detects that the wavelength of collimated output laser beam 1022 is incorrect, processor 1040 may direct a temperature change in Bragg reflector 1006.

Although the above-described embodiments of laser system 1000 are discussed with reference to thermoelectric devices 1008 inducing temperature changes in the Bragg reflectors 1006 and mounts 1052/1064, in other embodiments, other devices capable of inducing temperature changes may be used. Additionally, as with the above described embodiments (e.g., the embodiments of laser system 100 of FIG. 1 and laser system 900 of FIG. 9), pressure may be also used to adjust (or tune) the wavelength of Bragg reflector 1006 by, for example, using a transducer to squeeze or stretch Bragg reflector 1006.

Further, in yet another embodiment, rather than using temperature to induce a change, ΔL, in cavity length, L, of cavity 1032, a motor may be used to mechanically move, for example, Bragg reflector 1006 to effect the appropriate change in cavity length.

All documents, patents, journal articles and other materials cited in the present application are hereby incorporated by reference.

Although the present invention has been fully described in conjunction with several embodiments thereof with reference to the accompanying drawings, it is to be understood that various changes and modifications may be apparent to those skilled in the art. Such changes and modifications are to be understood as included within the scope of the present invention as defined by the appended claims, unless they depart therefrom.

1. A system for generating a coherent light beam, comprising:
a coherent light source;
a lens which collimates the light to provide a collimated coherent light beam; and
a reflective device which is tunable to reflect at least a portion of a tuned wavelength of light of the collimated coherent light beam, wherein the reflective device is responsive to at least one of temperature and/or pressure to adjust the tuned wavelength;
wherein the reflective device comprises a tunable Bragg reflector.

2. The system of claim 1, wherein the reflective device comprises a material comprising a Bragg grating.

3. The system of claim 2, wherein the Bragg grating is formed by parallel fringes and wherein the fringes comprise alternating indexes of refraction.

4. The system of claim 3, wherein the parallel fringes are formed by directing a plane wave coherent beam through the material which is reflected such that the plane wave passes back through the material to create a standing wave that forms the Bragg grating.

5. The system of claim 1, further comprising a thermoelectric device which can effect a temperature change in the reflective device to adjust the wavelength of light to which the reflective device is tuned.

6. The system of claim 1, further comprising:
a transducer which can effect a pressure change in the reflective device to adjust the wavelength of light to which the reflective device is tuned.

7. The system of claim 1, wherein the system comprises an optical cavity having an optical cavity length and wherein the optical cavity length can be adjusted.

8. The system of claim 7, further comprising a mount connected to the reflective device, wherein the optical cavity length can be adjusted by effecting at least one of a temperature, pressure, or mechanical change in the mount connected to the reflective device.

9. A method for generating a coherent light beam, comprising the following steps:
(a) providing a collimated coherent light beam; and
(b) adjusting at least one of a temperature of the reflective device and/or a pressure applied to the reflective device to tune the reflective device such that the reflective device reflects at least a portion of a tuned wavelength of light of the collimated coherent light beam, wherein the reflective device comprises a tunable Bragg reflector.

10. The method of claim 9, wherein the reflective device comprises a material comprising a Bragg grating.

11. The method of claim 10, further comprising forming the Bragg grating by effecting parallel fringes in the material, wherein the fringes comprise alternating indexes of refraction.

12. The method of claim 11, wherein forming the parallel fringes in the material comprises:
directing a plane wave through the material; and
reflecting the plane wave after passing through the material such that the plane wave is reflected back through the material.

13. The method of claim 9, further comprising adjusting a temperature of the reflective device to adjust the wavelength of light to which the reflective device is tuned.

14. The method of claim 9, further comprising adjusting a pressure applied to the reflective device to adjust the wavelength of light to which the reflective device is tuned.

15. The method of claim 9, wherein the system comprises an optical cavity having an optical cavity length, and wherein the method further comprises adjusting the optical cavity length.

16. The method of claim 15, wherein adjusting the optical cavity length comprises effecting at least one of a temperature, pressure, or mechanical change in a mount connected to the reflective device.

17. A system for generating a coherent light beam, comprising:
means for providing a collimated coherent light beam;
means for tuning a reflective device wherein the reflective device comprises a tunable Bragg reflector;
means for adjusting at least one of temperature of the tuning means and/or a pressure applied to the tuning means such that the tuning means reflects from the reflective device at least a portion of a tuned wavelength of light of the collimated coherent light beam.

18. The system of claim 17, wherein the tuning means comprises a material comprising a Bragg grating having parallel fringes in the material, wherein the fringes comprise alternating indexes of refraction.

19. The system of claim 17, further comprising means for adjusting a temperature of the tuning means to adjust the wavelength of light to which the tuning means is tuned.

20. The system of claim 17, further comprising means for adjusting a pressure applied to the tuning means to adjust the wavelength of light to which the tuning means is tuned.

21.-22. (canceled)
